(19) United States
(12) Patent Application Publication
(10) Pub. No.: US 2026/0098994 A1
(43) Pub. Date: Apr. 9, 2026

(54) LIGHT GUIDE PLATE, BACKLIGHT UNIT, AND LIQUID CRYSTAL DISPLAY DEVICE

(71) Applicant: Shanghai Tianma Micro-Electronics Co., Ltd., Shanghai (CN)

(72) Inventors: Takeru Hotta, Kawasaki (JP); Tomoharu Yokoyama, Kawasaki (JP)

(73) Assignee: Shanghai Tianma Micro-Electronics Co., Ltd., Shanghai (CN)

(21) Appl. No.: 19/346,751

(22) Filed: Oct. 1, 2025

(30) Foreign Application Priority Data
Oct. 3, 2024 (JP) 2024-174281
Jun. 27, 2025 (JP) 2025-109562

(51) Int. Cl. F21V 8/00; G02F 1/13357

(52) U.S. Cl. CPC G02B 6/0045; G02B 6/005; G02B 6/0091; G02F 1/133615

(57) ABSTRACT

A light guide plate includes a light incident surface through which light emitted from a light source is incident, and a light exit surface having a light exit region configured to allow the light to exit and peripheral regions adjoining the light exit region. The light guide plate includes at least one protrusion in the peripheral regions.

### CROSS-REFERENCE TO RELATED APPLICATIONS

This application claims the benefit of Japanese Patent Application No. 2024-174281, filed on Oct. 3, 2024, and Japanese Patent Application No. 2025-109562, filed on Jun. 27, 2025, of which the entirety of the disclosures is incorporated by reference herein.

### FIELD OF THE INVENTION

This application relates to a light guide plate, a backlight unit, and a liquid crystal display device.

### BACKGROUND OF THE INVENTION

Some liquid crystal display devices are provided with, as illumination means, a backlight unit including a light source, a light guide plate, and optical sheets, for example. The optical sheets adjust the properties of the light exiting from the light guide plate and entering a liquid crystal display panel. Examples of the optical sheets include a diffusion sheet, a prism sheet, and a polarizing reflective sheet. The backlight unit includes multiple optical sheets in general.

The optical sheets, made of a material, such as polyethylene terephthalate or polycarbonate, thermally expand after prolonged use of the liquid crystal display device. When the thermally expanded optical sheets cause their ends to contact adjacent components, the optical sheets may develop warpage or wrinkling. Such warpage or wrinkling in the optical sheets impairs the display quality of the liquid crystal display device. U.S. Patent Application Publication No. 2018/0095319 discloses a panel chassis for retaining a liquid crystal panel. This panel chassis includes a rib having an inclined surface to ensure the space for accommodating elongated optical sheets. The inclined surface of the rib has a descending inclination from the side adjacent to the optical sheet having a higher coefficient of thermal expansion, in the direction of stacking of the optical sheets.

The technique disclosed in U.S. Patent Application Publication No. 2018/0095319 brings the optical sheets into contact with the inclined surface of the rib of the panel chassis and intentionally bends the peripheries of the optical sheets along the inclined surface, possibly resulting in loads on the optical sheets. In addition, in order to meet recent demands for thinner frames in liquid crystal display devices or backlight units, the gap between the optical sheets and the chassis (that is, the width of the space for accommodating the elongated optical sheets) must be further reduced.

### SUMMARY OF THE INVENTION

A light guide plate according to a first aspect of the present disclosure includes:
a light incident surface through which light emitted from a light source is incident;
a light exit surface including
   a light exit region configured to allow the light to exit, and
   peripheral regions adjoining the light exit region; and
at least one protrusion in the peripheral regions.

A backlight unit according to a second aspect of the present disclosure includes:
a light source to emit light;
a light guide plate including
   a light incident surface through which the light emitted from the light source is incident, and
   a light exit surface including
      a light exit region configured to allow the light to exit, and
      peripheral regions adjoining the light exit region; and
an optical sheet mounted on the light exit surface of the light guide plate, wherein
the light guide plate includes at least one protrusion in the peripheral regions, and
the optical sheet is placed over the at least one protrusion when the optical sheet thermally expands.

A liquid crystal display device according to a third aspect of the present disclosure includes:
the above-described backlight unit; and
a liquid crystal display panel mounted on the backlight unit.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a sectional view of a liquid crystal display device according to Embodiment 1;

FIG. 2 is a plan view of a light guide plate, a light source, optical sheets, and a lower chassis of a backlight unit according to Embodiment 1;

FIG. 3 is a plan view of the light guide plate according to Embodiment 1;

FIG. 4 is a sectional view of the light guide plate, the optical sheets, and the lower chassis taken along the line A-A of FIG. 2;

FIG. 5 is a sectional view of the light guide plate, the light source, the optical sheets, and the lower chassis taken along the line B-B of FIG. 2;

FIG. 6 is a sectional view of a representative optical sheet after thermal expansion according to Embodiment 1;

FIG. 7 is a sectional view of a light guide plate and an optical sheet after thermal expansion according to Comparative Example 1;

FIG. 8 is a sectional view of a rib of an upper chassis according to Embodiment 1;

FIG. 9 is a plan view of a light guide plate according to Embodiment 2;

FIG. 10 is a plan view of the light guide plate and optical sheets according to Embodiment 2;

FIG. 11 is a schematic diagram illustrating a light guide plate and optical sheets according to Embodiment 3;

FIG. 12 is a schematic diagram for describing the width of a protrusion according to Embodiment 3;

FIG. 13 is another schematic diagram for describing the width of the protrusion according to Embodiment 3;

FIG. 14 is a schematic diagram illustrating a light guide plate and optical sheets according to Embodiment 4;

FIG. 15 is a plan view of a light guide plate according to a modification;

FIG. 16 is a sectional view of a light guide plate and optical sheets according to another modification;

FIG. 17 is a sectional view of a protrusion according to another modification;

FIG. 18 is a sectional view of a protrusion according to another modification; and

FIG. 19 is a sectional view of a protrusion according to another modification.

### DETAILED DESCRIPTION OF THE INVENTION

A light guide plate, a backlight unit, and a liquid crystal display device according to some embodiments are described below with reference to the accompanying drawings.

### Embodiment 1

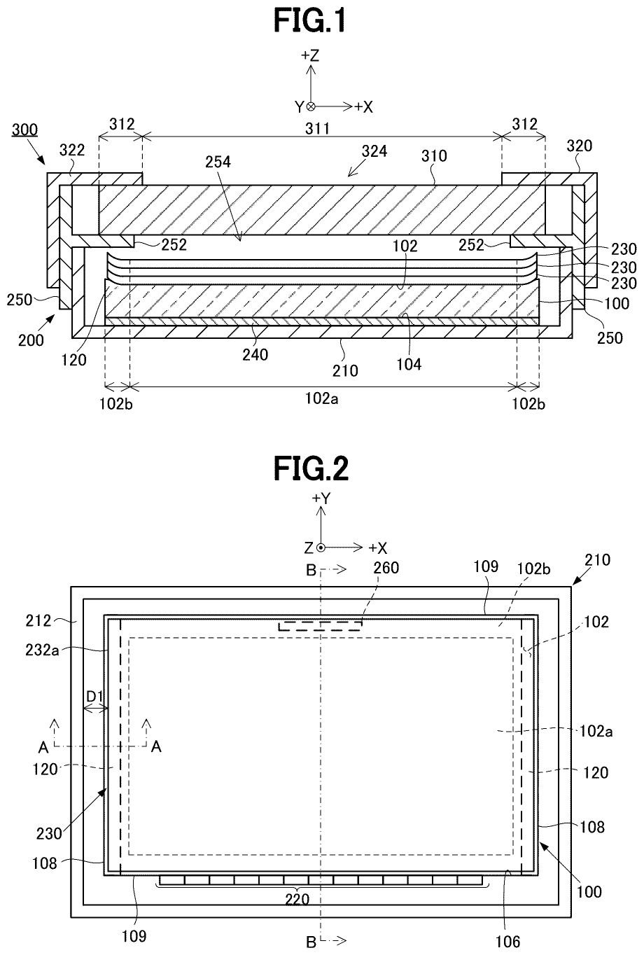

The following describes a light guide plate 100, a backlight unit 200, and a liquid crystal display device 300 according to an embodiment with reference to FIGS. 1 to 8. As illustrated in FIG. 1, the liquid crystal display device 300 includes a liquid crystal display panel 310 and the backlight unit 200. The backlight unit 200 includes a light guide plate 100. This specification defines the longitudinal direction of the liquid crystal display device 300 in FIG. 1 (that is, the rightward direction in the plane of the figure) as the +X direction, the transverse direction (that is, the direction extending into the plane of the figure) as the +Y direction, and the direction perpendicular to both the +X and +Y directions (that is, the upward direction in the plane of the figure, or the direction toward a user) as the +Z direction. FIG. 1 illustrates optical sheets 230, which are described below, without hatching, in order to facilitate an understanding. The other figures may also illustrate components without hatching.

The description starts with the light guide plate 100 and the backlight unit 200. The backlight unit 200 functions as illumination means for the liquid crystal display panel 310 of the liquid crystal display device 300. As illustrated in FIGS. 1 and 2, the backlight unit 200 includes the light guide plate 100, a lower chassis 210, light sources 220, optical sheets 230, a reflective sheet 240, and an upper chassis 250.

The light guide plate 100 is a rectangular plate member elongated in the X direction in plan view. The light guide plate 100 directs the light incident from the light sources 220 toward the liquid crystal display panel 310. As illustrated in FIGS. 1 to 3, the light guide plate 100 includes a main surface 102 (hereinafter referred to as “light exit surface 102”) having a light exit region 102a and peripheral regions 102b adjoining the light exit region 102a, a main surface 104 opposite to the light exit surface 102, and four side surfaces (end surfaces). The light exit region 102a of the light exit surface 102 allows light to exit toward the liquid crystal display panel 310. The peripheral regions 102b of the light exit surface 102 surround the light exit region 102a.

In this embodiment, the light emitted from the light sources 220 enters the light guide plate 100 through a side surface 106 (hereinafter referred to as “light incident surface 106”) located on the −Y side among the four side surfaces. The light incident through the light incident surface 106 is diffused within the light guide plate 100, and is guided through the light exit region 102a of the light exit surface 102 toward the liquid crystal display panel 310.

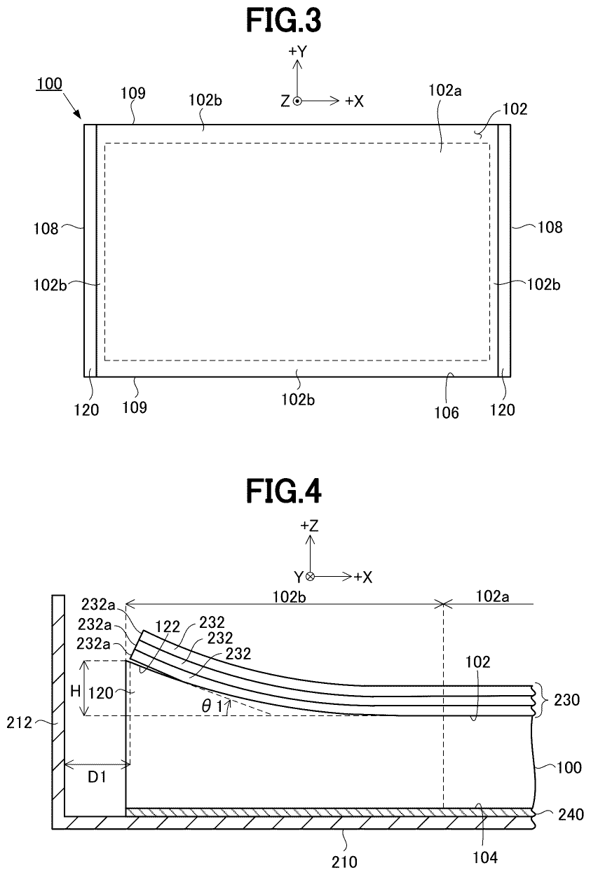

As illustrated in FIGS. 1 to 3, the light guide plate 100 has protrusions 120 in the peripheral regions 102b of the light exit surface 102. One of the protrusions 120 in the embodiment is disposed in the peripheral region 102b on a short side 108 located in the +X direction, and the other of the protrusions 120 is disposed in the peripheral region 102b on the other short side 108 located in the −X direction in plan view (FIG. 3). Each of the protrusions 120 extends along the end edge (short side 108) of the light guide plate 100 on a side where the protrusion 120 is provided. As illustrated in FIG. 4, the protrusion 120 has an inclined surface 122 inclined toward the light exit region 102a relative to the X direction in sectional view. The inclined surface 122 is gently curved.

The light guide plate 100 is made of a resin (for example, polycarbonate) having light permeability. For example, the light guide plate 100 includes fine prisms on the main surface 104.

As illustrated in FIGS. 1 and 2, the lower chassis 210 has a box shape. The lower chassis 210 is made of a resin or metal. The lower chassis 210 accommodates the light guide plate 100, the light sources 220, the optical sheets 230, and the reflective sheet 240 therein.

As illustrated in FIG. 2, the structure has a gap D1 defined between a lateral plate 212 of the lower chassis 210 and end faces 232a of the optical sheets 230 before thermal expansion. The gap D1 prevents contact between the lateral plate 212 of the lower chassis 210 and the end faces 232b of the optical sheets 230 after thermal expansion, thereby protecting the optical sheets 230 from warpage or wrinkling. The thermal expansion of the optical sheets 230, the optical sheets 230 before thermal expansion, the end faces 232b, and other details are described below.

The light sources 220 are white light emitting diode (LED) elements, for example. As illustrated in FIGS. 2 and 5, the light sources 220 are arranged along the light incident surface 106 of the light guide plate 100. The light emitted from the light sources 220 enters the light guide plate 100 through the light incident surface 106.

As illustrated in FIGS. 1 and 2, the optical sheets 230 are mounted on the light exit surface 102 of the light guide plate 100. The optical sheets 230 adjust the properties of the light exiting through the light exit region 102a of the light exit surface 102 and entering the liquid crystal display panel 310. Examples of the optical sheets 230 include a diffusion sheet, a prism sheet, and a polarizing reflective sheet. The diffusion sheet is made of polyethylene terephthalate, for example, and diffuses the transmitted light. The prism sheet is made of polyethylene terephthalate, for example, and condenses the transmitted light. The polarizing reflective sheet is made of polycarbonate, for example. The polarizing reflective sheet transmits light having a certain direction of polarization, and reflects light having directions of polarization other than the certain direction of polarization. The optical sheets 230 in the embodiment consist of three optical sheets 230 including a diffusion sheet, a prism sheet, and a polarizing reflective sheet stacked in this order from the side adjacent to the light exit surface 102.

The three optical sheets 230 are stacked on each other and bonded to one of the peripheral regions 102b of the light exit surface 102 of the light guide plate 100. As illustrated in FIG. 2, the optical sheets 230 are bonded with a double-sided tape 260 to the center of the peripheral region 102b on a long side 109 located in the +Y direction.

The optical sheets 230 have a rectangular contour elongated in the X direction smaller than the contour of the light exit surface 102 of the light guide plate 100 in plan view. As illustrated in FIG. 4, the optical sheets 230 before thermal expansion have edges 232 placed over the protrusions 120 of the light guide plate 100. The optical sheets 230 before thermal expansion indicate the optical sheets 230 before the start of use of the liquid crystal display device 300, for example, at a temperature of 25° C.

The optical sheets 230 expand due to heat emitted from the light sources 220 and other electronic components disposed around the backlight unit 200. The optical sheets 230 after thermal expansion indicate the optical sheets 230 that have expanded due to heat.

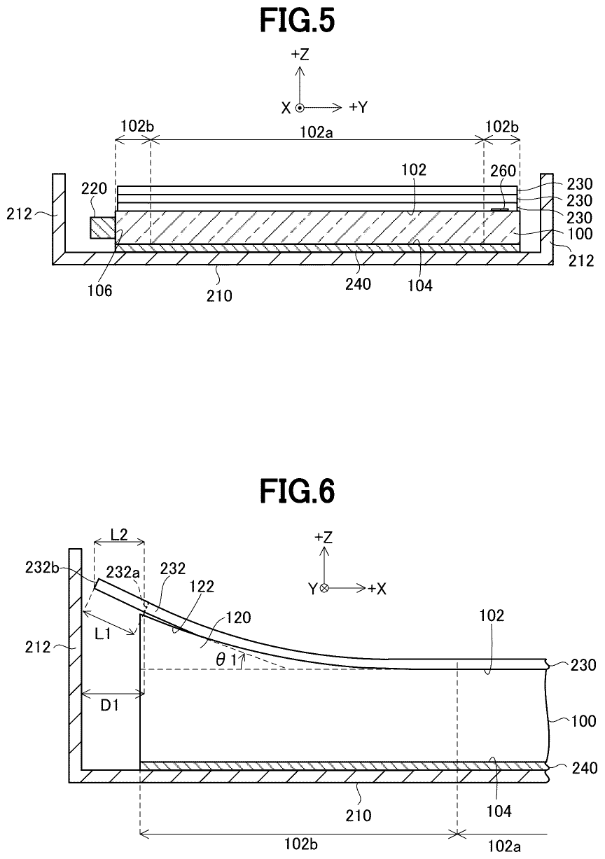

FIG. 6 is a sectional view of a representative optical sheet 230 after thermal expansion. The reference numeral 232a represents the end face of the optical sheet 230 before thermal expansion, whereas the reference numeral 232b represents the end face of the optical sheet 230 after thermal expansion. FIG. 6 illustrates a single optical sheet 230 alone in order to facilitate an understanding.

In this embodiment, the edge 232 of the optical sheet 230 before thermal expansion is placed over the protrusion 120 of the light guide plate 100. The optical sheet 230 while expanding elongates along the inclined surface 122 of the protrusion 120, as illustrated in FIG. 6. The optical sheet 230 elongates in a direction inclined from the X direction because the inclined surface 122 is inclined from the X direction. The optical sheet 230 thus extends due to thermal expansion by a length L2 in the X direction shorter than a length L1 of actual elongation of the optical sheet 230 due to thermal expansion, at one end of the backlight unit 200 in the X direction. This structure can reduce the gap D1 between the lateral plate 212 of the lower chassis 210 and the end faces 232a of the optical sheets 230 before thermal expansion, because the gap D1 is only required to be longer than the X-direction length L2 of extension of the optical sheet 230 due to thermal expansion and can be shorter than the length L1 of actual elongation of the optical sheet 230 due to thermal expansion.

The following describes an exemplary comparative backlight unit (hereinafter referred to as “backlight unit in Comparative Example 1”) in which exemplary optical sheets 230 made of polyethylene terephthalate are bonded with a double-sided tape 260 to the center of a peripheral region 102b on a long side 109 of a light guide plate 100A having no protrusion 120. When this exemplary comparative backlight unit was heated from 25° C. to 95° C., the long sides of the optical sheets 230 increased by 0.9 mm. These exemplary optical sheets 230 at a temperature of 25° C. have a length of 267.61 mm on its long side and 159.60 mm on its short side. The light guide plate 100A has the configuration identical to the light guide plate 100 except for that the light guide plate 100A has no protrusion 120. The exemplary comparative backlight unit has the configuration identical to the backlight unit 200 except for the light guide plate 100A.

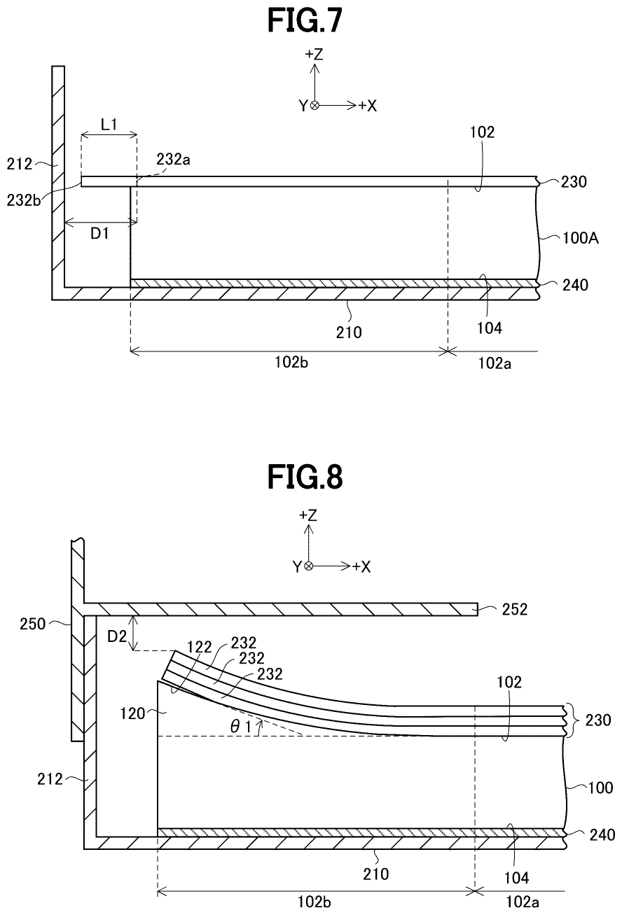

Since the long sides of the optical sheets 230 of the backlight unit in Comparative Example 1 increased by 0.9 mm, the length L1 of actual elongation of the optical sheets 230 due to thermal expansion was 0.45 mm (equal to the half of 0.9 mm) at one end of the exemplary comparative backlight unit in the X direction. Accordingly, the width (X-direction length) of the gap D1 in the backlight unit in Comparative Example 1 is required to be larger than 0.45 mm (length L1), in order to prevent contact between the lateral plate 212 of the lower chassis 210 and the end faces 232b of the optical sheets 230 after thermal expansion, as illustrated in FIG. 7.

In contrast, when the backlight unit 200, which includes the light guide plate 100 and the above-mentioned exemplary optical sheets 230, was heated from 20° C. to 95° C., the X-direction length L2 of extension of the optical sheets 230 due to thermal expansion was found to be 0.37 mm at one end of the backlight unit 200 in the X direction. The width of the gap D1 in this backlight unit 200 is thus only required to be larger than 0.37 mm. That is, the backlight unit 200 can achieve a reduced gap D1 compared to that in the backlight unit in Comparative Example 1. The inclined surfaces 122 of the protrusions 120 have the maximum angle θ1 of 20°, and the protrusions 120 have a height H of 2.0 mm.

The reflective sheet 240 is disposed on the main surface 104 of the light guide plate 100, as illustrated in FIG. 5. The reflective sheet 240 reflects the light emitted from the main surface 104 of the light guide plate 100 toward the light guide plate 100.

The upper chassis 250 has a frame shape. The upper chassis 250 has a rib 252 extending inward, as illustrated in FIG. 1. The upper chassis 250 is made of a synthetic resin, for example. The rib 252 overlaps with the peripheral regions 102b of the light guide plate 100 and the portions of the optical sheets 230 corresponding to the peripheral regions 102b of the light guide plate 100, and defines an opening 254. The opening 254 exposes the light exit region 102a of the light guide plate 100.

As illustrated in FIG. 8, the rib 252 and the optical sheets 230 preferably define a gap D2 therebetween. The gap D2 can prevent contact between the optical sheets 230 and the rib 252.

This structure, which includes the optical sheets 230 placed over the protrusions 120 of the light guide plate 100 as described above, can reduce the gap D1 between the lateral plate 212 of the lower chassis 210 and the end faces 232a of the optical sheets 230 before thermal expansion, thereby enabling a thinner frame of the backlight unit 200. The backlight unit 200, which includes the gap D1, can prevent contact between the lateral plate 212 of the lower chassis 210 and the end faces 232b of the optical sheets 230 after thermal expansion, leading to reduced warpage or wrinkling in the optical sheets 230.

The following describes the liquid crystal display device 300. The liquid crystal display device 300 displays characters, images, and other information. As illustrated in FIG. 1, the liquid crystal display device 300 includes the above-described backlight unit 200, the liquid crystal display panel 310, and a bezel 320. The description focuses on the liquid crystal display panel 310 and the bezel 320.

The liquid crystal display panel 310 is mounted on the rib 252 of the upper chassis 250 of the backlight unit 200. The liquid crystal display panel 310 is a publicly known transmissive liquid crystal display panel of the in-plane switching type, for example. The liquid crystal display panel 310 is driven by an active matrix of thin film transistors (TFTs). The liquid crystal display panel 310 displays characters, images, and other information, by modulating the light from the backlight unit 200. The liquid crystal display panel 310 has a display region 311 and peripheral regions 312. The display region 311 includes pixels arranged in a matrix, and can display characters, images, and other information. The peripheral regions 312 include components, such as wires and drive circuits.

The bezel 320 has a box shape. The bezel 320 has an opening 324 in a top base 322, as illustrated in FIG. 1. The bezel 320 is made of a metal, for example. The bezel 320 covers the upper chassis 250 of the backlight unit 200 such that the top base 322 faces the +Z side, and protects the peripheral regions 312 of the liquid crystal display panel 310. The opening 324 exposes the display region 311 of the liquid crystal display panel 310.

The light guide plate 100 of the backlight unit 200 includes the protrusions 120 in the peripheral regions 102b of the light exit surface 102, and the edges 232 of the optical sheets 230 are placed over the protrusions 120, as described above. The edges 232 of the optical sheets 230 are elongated on the inclined surfaces 122 of the protrusions 120 in the direction inclined from the X direction during thermal expansion of the optical sheets 230. This structure can reduce the gap D1 between the lateral plate 212 of the lower chassis 210 and the end faces 232a of the optical sheets 230 before thermal expansion. The backlight unit 200 can thus enable a thinner frame. The liquid crystal display device 300, which includes the backlight unit 200, can also enable a thinner frame.

### Embodiment 2

In Embodiment 1, the optical sheets 230 are bonded to the center of the peripheral region 102b on the long side 109 of the light guide plate 100. The optical sheets 230 may also be bonded to the peripheral region 102b on the short side 108 of the light guide plate 100.

The backlight unit 200 in the embodiment has the configuration identical to the backlight unit in Embodiment 1 except for the structure of the protrusion 120 of the light guide plate 100 and the bonding position of the optical sheets 230. The description focuses on the structure of the protrusion 120 of the light guide plate 100 and the bonding position of the optical sheets 230.

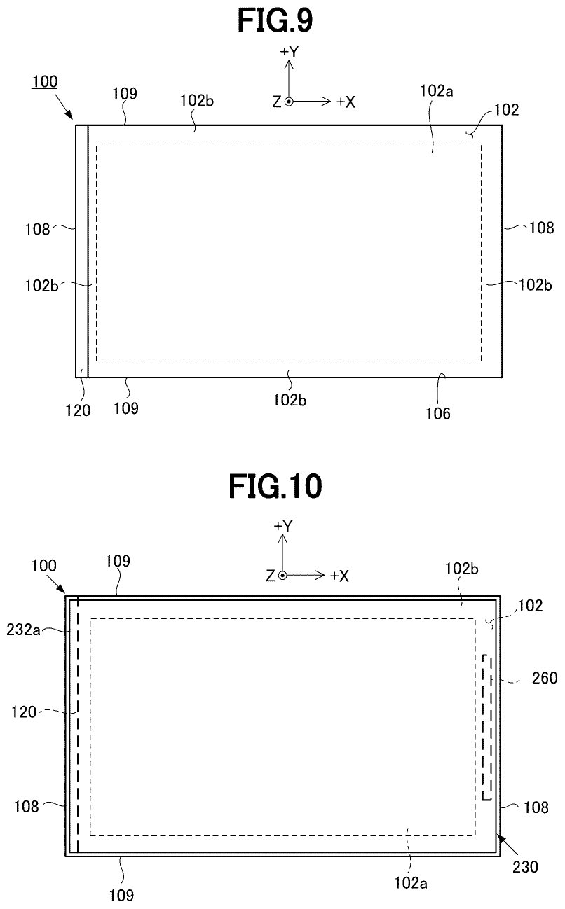

As illustrated in FIG. 9, only the peripheral region 102b on the short side 108 located in the −X direction includes the protrusion 120 of the light guide plate 100 in the embodiment. The other features of the protrusion 120 in the embodiment are identical to those of the protrusions 120 in Embodiment 1.

As illustrated in FIG. 10, the optical sheets 230 in the embodiment are bonded with a double-sided tape 260 to the peripheral region 102b on the short side 108 located in the +X direction. The edges 232 of the optical sheets 230 before thermal expansion in the embodiment are placed over the protrusion 120 of the light guide plate 100, like the edges 232 of the optical sheets 230 in Embodiment 1. The other features of the optical sheets 230 in the embodiment are identical to those of the optical sheets 230 in Embodiment 1.

The edges 232 of the optical sheets 230 in the embodiment are also placed over the protrusion 120 of the light guide plate 100. The edges 232 of the elongated optical sheets 230 are thus elongated in the direction inclined from the X direction during thermal expansion of the optical sheets 230. The backlight unit 200 can thus achieve a reduced gap D1 between the lateral plate 212 of the lower chassis 210 and the end faces 232a of the optical sheets 230 before thermal expansion.

The following describes an exemplary comparative backlight unit (hereinafter referred to as “backlight unit in Comparative Example 2”) in which exemplary optical sheets 230 are bonded with a double-sided tape 260 to a peripheral region 102b on a short side 108 located in the +X direction in a light guide plate 100A having no protrusion 120. When this exemplary comparative backlight unit was heated from 25° C. to 95° C., the edges 232 of the elongated optical sheets 230 on the −X side were elongated by 1.3 mm. The exemplary optical sheets 230 have the configuration identical to the exemplary optical sheets 230 in Embodiment 1. The light guide plate 100A has the configuration identical to the light guide plate 100 in the embodiment except for that the light guide plate 100A has no protrusion 120. The backlight unit in Comparative Example 2 has the configuration identical to the backlight unit 200 except for the light guide plate 100A.

The edges 232 of the elongated optical sheets 230 on the −X side were elongated by 1.3 mm in the backlight unit in Comparative Example 2. Accordingly, the width of the gap D1 between the lateral plate 212 of the lower chassis 210 on the −X side and the end faces 232a of the optical sheets 230 on the −X side before thermal expansion is required to be larger than 1.30 mm (length L1) in the backlight unit in Comparative Example 2, in order to prevent contact between the lateral plate 212 of the lower chassis 210 and the end faces 232b of the optical sheets 230 after thermal expansion.

In contrast, when the backlight unit 200 in the embodiment, which includes the light guide plate 100 and the above-mentioned exemplary optical sheets 230, was heated from 20° C. to 95° C., the X-direction length L2 of extension of the optical sheets 230 due to thermal expansion was found to be 1.15 mm. The width of the gap D1 on the −X side in this backlight unit 200 is thus only required to be larger than 1.15 mm. That is, the backlight unit 200 in the embodiment can achieve a reduced gap D1 compared to that in the backlight unit in Comparative Example 2. The inclined surface 122 of the protrusion 120 has the maximum angle θ1 of 20°, and the protrusion 120 has a height H of 3.2 mm.

The backlight unit 200 in the embodiment can therefore achieve a reduced gap D1 between the lateral plate 212 of the lower chassis 210 and the end faces 232a of the optical sheets 230 before thermal expansion, as described above. The backlight unit 200 in the embodiment can thus enable a thinner frame. The liquid crystal display device 300, which includes the backlight unit 200 in the embodiment, can also enable a thinner frame.

### Embodiment 3

The description in this embodiment focuses on a width (X-direction length) W1 of the protrusions 120 of the light guide plate 100.

The optical sheets 230 in the embodiment are bonded with a double-sided tape 260 to the center of the peripheral region 102b on the long side 109 of the light guide plate 100, as in Embodiment 1. The edges 232 of the optical sheets 230 before thermal expansion are placed over the protrusions 120 of the light guide plate 100, as in Embodiment 1.

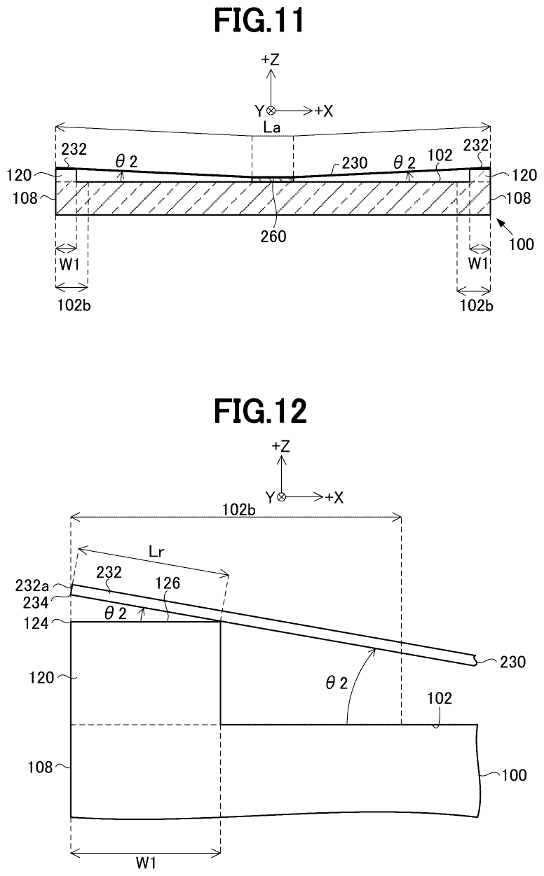

One of the protrusions 120 of the light guide plate 100 in the embodiment is disposed in the peripheral region 102b on the short side 108 located in the +X direction, and the other of the protrusions 120 is disposed in the peripheral region 102b on the short side 108 located in the −X direction (FIG. 11), as in Embodiment 1. The protrusions 120 of the light guide plate 100 in the embodiment have a rectangular shape in sectional view, as illustrated in FIGS. 11 and 12.

The protrusions 120 may have any shape provided that the protrusions 120 can receive the edges 232 of the optical sheets 230 placed thereover, as is described below. FIG. 11 illustrates the optical sheets 230 with a single bold line in order to facilitate an understanding.

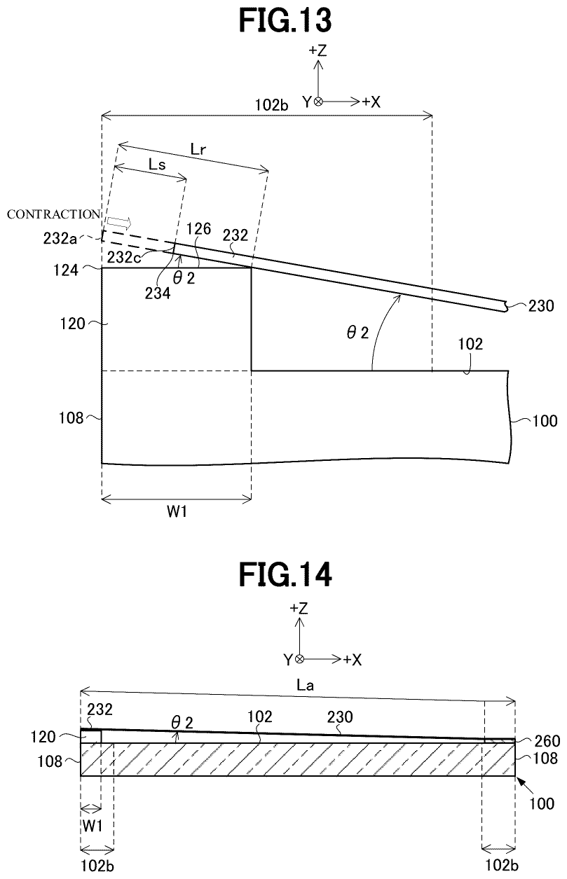

If the edges 232 of the optical sheets 230 once slip off the protrusions 120 of the light guide plate 100 due to contraction of the optical sheets 230, the edges 232 of the optical sheets 230 may fail to return to their original position over the protrusions 120 of the light guide plate 100 even after re-expansion of the optical sheets 230. The edges 232 of the optical sheets 230 are thus desired to maintain the state of being placed over the protrusions 120 of the light guide plate 100 in the operating temperature range (for example, environmental temperatures of −40° C. to 95° C.). The following assumes an example in which an optical sheet 230 is mounted on the light guide plate 100 at a temperature of 25° C. such that an outermost tip 234 of the edge 232 of the optical sheet 230 is aligned to an outer edge 124 of each protrusion 120, as illustrated in FIG. 12. In this example, the outermost tip 234 of the edge 232 of the optical sheet 230 after contraction is desired to be positioned over an upper surface 126 of the protrusion 120, as illustrated in FIG. 13, at the lower limit temperature Tm (for example, Tm=−40° C.) of the operating temperature range. In FIG. 13, the reference numeral 232c represents the end face of the optical sheet 230 after contraction.

In order to locate the outermost tip 234 of the edge 232 of the optical sheet 230 after contraction above the upper surface 126 of the protrusion 120 as described above, a length Lr of the edge 232 of the optical sheet 230 overlapping with the protrusion 120 at a temperature of 25° C. is required to be longer than a length Ls of contraction of the optical sheet 230 above the protrusion 120 after a temperature drop from 25° C. to the lower limit temperature Tm (that is, Lr>Ls). The length Lr is represented by Expression (1) below, where θ2 indicates the angle of the edge 232 of the optical sheet 230 relative to the upper surface 126 of the protrusion 120 (or the light exit surface 102 of the light guide plate 100). The length Ls is represented by Expression (2) below, where a indicates the coefficient of thermal expansion of the optical sheets 230, and La indicates the length of the optical sheets 230 mounted on the light guide plate 100 at a temperature of 25° C., because the optical sheets 230 are bonded to the center of the peripheral region 102b on the long side 109 of the light guide plate 100, and the protrusions 120 are provided to the peripheral region 102b of the light guide plate 100 located in the +X direction and the peripheral region 102b located in the −X direction.

$$Lr = \frac{W 1}{cos ( θ2 )} \qquad ( 1 )$$

$$Ls = La \times α \times ( 25 - Tm ) \times \frac{1}{2} \qquad ( 2 )$$

Expressions (1) and (2) above and the condition that the length Lr is longer than the length Ls (Lr>Ls) demonstrate that the width W1 of the protrusions 120 in the embodiment is desired to satisfy Expression (3) below:

$$W 1 > \frac{1}{2} \times La \times α \times ( 25 - Tm ) \times cos ( θ2 ) \qquad ( 3 )$$

In an exemplary case where the length La of the optical sheets 230 designed for the liquid crystal display panel 310 having a diagonal size of 4.2 inches is 98.8 mm, the coefficient α of thermal expansion of the optical sheets 230 is 7.59×10⁻⁵/° C., the angle θ2 is 20°, and the lower limit temperature Tm is −40° C., Expression (3) reveals that the width W1 of the protrusions 120 is desired to be larger than 0.23 mm. In another exemplary case where the length La of the optical sheets 230 designed for the liquid crystal display panel 310 having a diagonal size of 14 inches is 314.5 mm, and the coefficient α of thermal expansion, the angle θ2, and the lower limit temperature Tm have the above-mentioned values (a coefficient α of thermal expansion of 7.59×10⁻⁵/° C., an angle θ2 of 20°, and a lower limit temperature Tm of −40° C.), Expression (3) reveals that the width W1 of the protrusions 120 is desired to be larger than 0.73 mm.

### Embodiment 4

In Embodiment 3, the optical sheets 230 are bonded to the center of the peripheral region 102b on the long side 109 of the light guide plate 100. The description in this embodiment focuses on the width W1 of the protrusion 120 of the light guide plate 100 in which the optical sheets 230 are bonded to a peripheral region 102b on the short side 108 of the light guide plate 100.

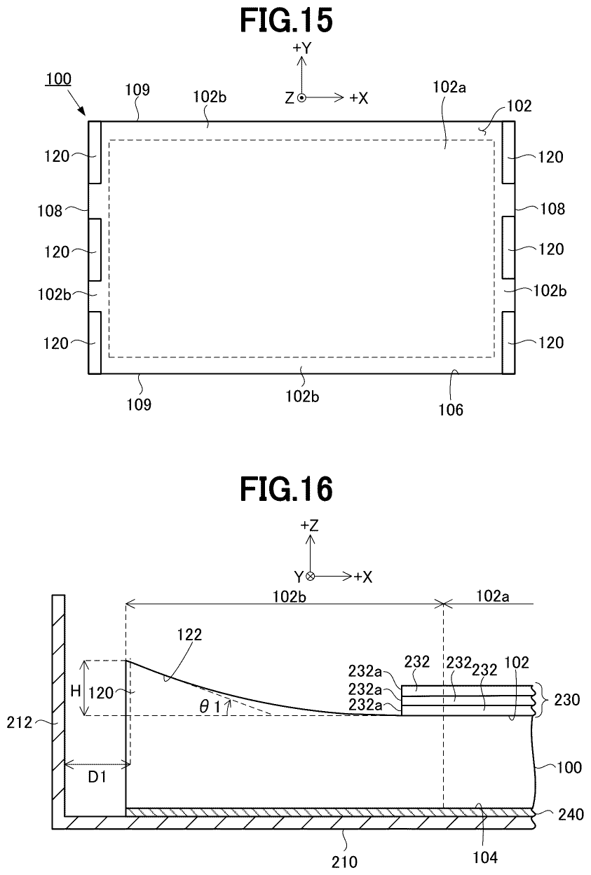

The optical sheets 230 in the embodiment are bonded with a double-sided tape 260 to the peripheral region 102b on the short side 108 located in the +X direction (FIG. 14), as in Embodiment 2. The edges 232 of the optical sheets 230 before thermal expansion are placed over the protrusion 120 of the light guide plate 100, as in Embodiment 2. FIG. 14 illustrates the optical sheets 230 with a single bold line, in order to facilitate an understanding.

In the embodiment, only the peripheral region 102b on the short side 108 located in the −X direction includes the protrusion 120 of the light guide plate 100, as in Embodiment 2. The protrusion 120 of the light guide plate 100 in the embodiment has a rectangular shape in sectional view, as illustrated in FIG. 14.

The edges 232 of the optical sheets 230 in the embodiment are desired to maintain the state of being placed over the protrusion 120 of the light guide plate 100 in the operating temperature range (for example, environmental temperatures of −40° C. to 95° C.), as in Embodiment 3. When the optical sheets 230 are mounted on the light guide plate 100 at a temperature of 25° C. such that the outermost tips 234 of the edges 232 of the optical sheets 230 are aligned to an outer edge 124 of the protrusion 120, the length Lr of the edges 232 of the optical sheets 230 overlapping with the protrusion 120 at a temperature of 25° C. is required to be longer than the length Ls of contraction of the optical sheets 230 above the protrusion 120 after a temperature drop from 25° C. to the lower limit temperature Tm (that is, Lr>Ls), as in Embodiment 3.

The length Lr in the embodiment is also represented by Expression (1) above. The length Ls is represented by Expression (4) below, because the optical sheets 230 are bonded to the peripheral region 102b on the short side 108 located in the +X direction, and the protrusion 120 is provided to only the peripheral region 102b on the short side 108 located in the −X direction.

$$Ls = La \times α \times ( 25 - Tm ) \qquad ( 4 )$$

Expressions (1) and (4) above and the condition that the length Lr is longer than the length Ls (Lr>Ls) demonstrate that the width W1 of the protrusion 120 in the embodiment is desired to satisfy Expression (5) below:

$$W 1 > La \times α \times ( 25 - Tm ) \times cos ( θ2 ) \qquad ( 5 )$$

In an exemplary case where the length La of the optical sheets 230 designed for the liquid crystal display panel 310 having a diagonal size of 4.2 inches is 98.8 mm, the coefficient α of thermal expansion of the optical sheets 230 is 7.59×10⁻⁵/° C., the angle θ2 is 20°, and the lower limit temperature Tm is −40° C., Expression (5) reveals that the width W1 of the protrusion 120 is desired to be larger than 0.46 mm. In another exemplary case where the length La of the optical sheets 230 designed for the liquid crystal display panel 310 having a diagonal size of 14 inches is 314.5 mm, and the coefficient α of thermal expansion of the optical sheets 230, the angle θ2, and the lower limit temperature Tm have the above-mentioned values, Expression (5) reveals that the width W1 of the protrusion 120 is desired to be larger than 1.46 mm.

### Modifications

The above-described embodiments may be modified in various manners within the gist of the present disclosure.

For example, the backlight unit 200 is only required to include at least one optical sheet 230.

The backlight unit 200 in the above embodiments is an edge-lit backlight unit that causes the light emitted from the light sources 220 to enter the side surface 106 (light incident surface 106) of the light guide plate 100. The backlight unit 200 may also be a direct-lit backlight unit that causes the light emitted from the light sources 220 to enter the main surface 104 of the light guide plate 100. In this modification, the main surface 104 of the light guide plate 100 corresponds to the light incident surface.

The light guide plate 100 in the above embodiments has a rectangular contour in plan view. The light guide plate 100 may also have a contour other than the rectangular contour in plan view.

The one or more protrusions 120 of the light guide plate 100 are provided to the peripheral regions 102b on the short sides 108 in the above embodiments. The protrusions 120 of the light guide plate 100 are only required to be provided to the peripheral regions 102b. For example, one or more protrusions 120 of the light guide plate 100 may be provided to the peripheral regions 102b on the long sides 109. Alternatively, one or more protrusions 120 of the light guide plate 100 may be provided to both the peripheral region 102b on the short side 108 and the peripheral region 102b on the long side 109.

The peripheral region 102b on the short side 108 includes a single protrusion 120 in the above embodiments. The peripheral region 102b on the short side 108 may have multiple protrusions 120, as illustrated in FIG. 15. The protrusions 120 are aligned along the end edge (short side 108) on a side where the protrusion 120 is provided.

The edges 232 of the optical sheets 230 before thermal expansion are placed over the one or more protrusions 120 of the light guide plate 100 in the above embodiments. The optical sheets 230 are only required to be placed over the protrusions 120 of the light guide plate 100 after thermal expansion of the optical sheets 230. In other words, the optical sheets 230 only need to be in the state of being placed over the protrusions 120 of the light guide plate 100 when the optical sheets 230 thermally expands.

Provided that the optical sheets 230 are placed over the one or more protrusions 120 of the light guide plate 100 after thermal expansion of the optical sheets 230, the gap D1 can be reduced by the structure in which the optical sheets 230 after thermal expansion elongate in a direction inclined from the X direction as in the above embodiments. For example, the optical sheets 230 before thermal expansion are not necessarily placed over the protrusions 120, as illustrated in FIG. 16, as long as the optical sheets 230 after thermal expansion are placed over the protrusions 120.

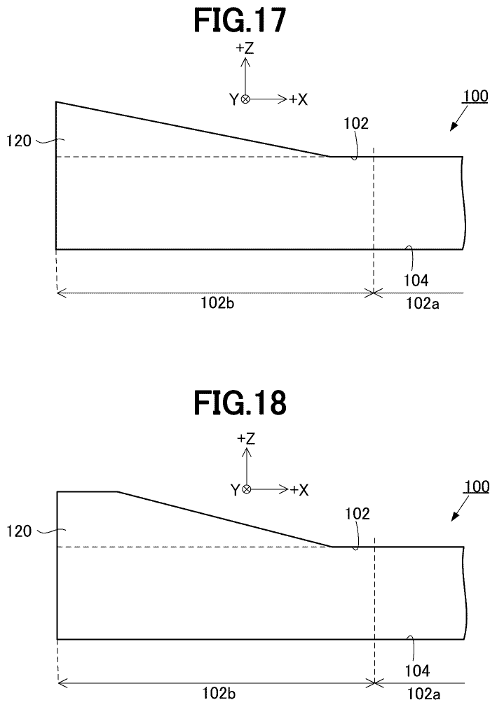

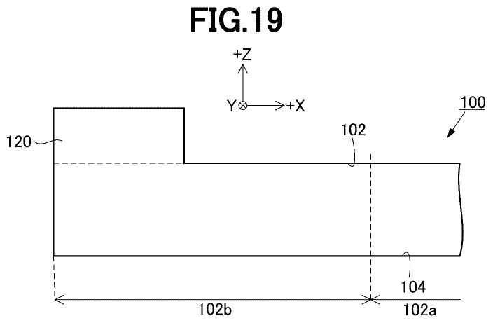

The one or more protrusions 120 may have any shape provided that the protrusions 120 can receive the optical sheets 230 before thermal expansion placed over the protrusions 120. For example, the protrusions 120 may have a shape of triangle, trapezoid, or rectangular in sectional view, as illustrated in FIGS. 17 to 19. Alternatively, the protrusions 120 may have a shape such that the protrusions 120 can receive the optical sheets 230 to be placed over the protrusions 120 during or after thermal expansion of the optical sheets 230.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A light guide plate, comprising:
a light incident surface through which light emitted from a light source is incident;
a light exit surface including
a light exit region configured to allow the light to exit, and
peripheral regions adjoining the light exit region; and
at least one protrusion in the peripheral regions.

2. The light guide plate according to claim 1, wherein the at least one protrusion extends along an end edge on a side where the at least one protrusion is provided, in plan view of the light exit surface.

3. The light guide plate according to claim 1, wherein
a plurality of the protrusions is aligned along an end edge where the plurality of protrusions is provided, in plan view of the light exit surface.

4. A backlight unit, comprising:
a light source to emit light;
a light guide plate including
a light incident surface through which the light emitted from the light source is incident, and
a light exit surface including
a light exit region configured to allow the light to exit, and
peripheral regions adjoining the light exit region; and
an optical sheet mounted on the light exit surface of the light guide plate, wherein
the light guide plate includes at least one protrusion in the peripheral regions, and
the optical sheet is placed over the at least one protrusion when the optical sheet thermally expands.

5. The backlight unit according to claim 4, wherein the at least one protrusion extends along an end edge on a side where the at least one protrusion is provided, in plan view of the light exit surface.

6. The backlight unit according to claim 4, wherein
a plurality of the protrusions is aligned along an end edge where the plurality of protrusions is provided, in plan view of the light exit surface.

7. The backlight unit according to claim 4, further comprising:
a chassis configured to cover the peripheral regions of the light exit surface and portions of the optical sheet corresponding to the peripheral regions of the light exit surface, wherein
the portions of the optical sheet corresponding to the peripheral regions of the light exit surface and the chassis define a gap therebetween.

8. The backlight unit according to claim 4, wherein
the light exit surface has a rectangular shape in plan view of the light exit surface,
the optical sheet is bonded to one of the peripheral regions of the light exit surface on a long side, and
the at least one protrusion is provided to one of the peripheral regions of the light exit surface on a short side.

9. The backlight unit according to claim 4, wherein the optical sheet maintains a state of being placed over the at least one protrusion in an operating temperature range.

10. A liquid crystal display device, comprising:
the backlight unit according to claim 4; and
a liquid crystal display panel mounted on the backlight unit.
